(19) United States
(12) Patent Application Publication
(10) Pub. No.: US 2004/0152522 A1
(43) Pub. Date: Aug. 5, 2004

(54) Arcade style video game adapter system

(75) Inventor: Christopher L. Gerding, Wadsworth, OH (US)

Correspondence Address: HAHN LOESER & PARKS, LLP, TWIN OAKS ESTATE, 1225 W. MARKET STREET, AKRON, OH, 44313, US

(73) Assignee: Quasimoto

(21) Appl. No.: 10/719,033

(22) Filed: Nov. 21, 2003

Related U.S. Application Data
(63) Continuation of application No. 09/781,069, filed on Feb. 9, 2001, now abandoned.
(60) Provisional application No. 60/218,308, filed on Jul. 14, 2000.

(51) Int. Cl. G06F 17/00

(52) U.S. Cl. 463/46

(57) ABSTRACT

The present invention relates to a video game adapter system for housing a home video game system and its required monitor or television, and converting to at least one arcade style feature. Multiple game systems can be housed within the cabinet to allow for even a greater variety of games to be played. Additionally, other audio-visual components may be housed within the cabinet of the present invention such as, for example, a Digital Video Disc (“DVD”) player, Compact Disc (“CD”) player, radio receiver, VCR, and/or an audio cassette player to make the cabinet into a full range entertainment center. The invention allows multiple game systems to be connected simultaneously to a universal control device, game systems and games can be selected quickly and easily.

### FIELD OF THE INVENTION

The present invention generally relates to a video game adapter system, which allows multiple home video game systems to be adapted to an arcade style game.

### BACKGROUND OF THE INVENTION

In the video game industry, home video game systems have become more and more popular since their inception, due to increased graphical capabilities, low price, and the availability of a large selection of games. This is contrasted to the arcade style video game units, which provide only one dedicated game per cabinet. Purchasing an arcade game for the home environment therefore becomes impractical. On the other hand, home game systems also tend to create clutter around the home television the system is connected to, with games and controllers typically left out after play.

At the same time, arcade style video games offer a number of attractive features, such as arcade style controllers and joysticks, which are not found in a home game system. The arcade games also may have a stereo system for enhancing the sound of the game. Other possible unique features may include a vibrating seat or the like, and an angled screen, which allows players to remain close to the game. All of these features enhance the experience of playing the video game.

Although the home video game units allow for a broader range of video games to be played by the unit, it would desirable to have arcade style features, and the ability to consolidate and hide the games, game system and controllers, when not in use. It would also be worthwhile to provide a system, which allows multiple game systems to be used with an independent set of controllers, preferably using arcade style controls. Therefore, it would be desirable to provide a video game adapter system that allows home video game systems to be converted to include arcade style video game features.

### SUMMARY OF THE INVENTION

The present invention allows for the housing of a home video game system and its required monitor or television within a cabinet, which can be converted to an arcade style game when desired. Multiple game systems and/or a computer, can be housed within the cabinet to allow for even a greater variety of games to be played. Additionally, other audio-visual components may be housed within the cabinet of the present invention such as, for example, a Digital Video Disc (“DVD”) player, Compact Disc (“CD”) player, radio receiver, VCR, and/or an audio components such as a cassette player to make the cabinet into a full range entertainment center that also contains arcade style features.

It is therefore an object of the present invention to provide a video game adapting system that allows for use of a home video game system with at least one arcade style feature.

It is a further object of the present invention to provide a cabinet that houses a television or monitor that may be automatically tilted at different angles to allow for regular television viewing, sit-down or stand-up play of a video game system.

It is another object of the present invention to provide a cabinet for housing and organizing a home video game systems and required television or monitor that can also house additional entertainment systems such as DVD players, CD players, audio receivers, or other video game systems.

It is another object of the present invention to provide an arcade style control panel that works with multiple game systems simultaneously without interference or signal crossing between game systems. This system provides quick selection of game system, and may use the arcade style control modules, and audio systems for the desired game system.

It is another object of the present invention to provide a quick way to select and change the game for a game system, such as by use of a device such a CD Changer that expedites and automates game swapping.

It is a further object of the invention to provide a wireless control device, being compatible with multiple game systems. The wireless control device may therefore allow the arcade style controls to be used in a control module which is selectively removable from the system according to the invention for providing wireless control from a remote location from the game cabinet.

It is another object of the present invention to create a simple method to allow selective control of play using a home game system, such as by use of a timing device that enables and disables game controllers and/or other components of a home game system.

It is another object of the present invention to integrate arcade style features into traditional cabinets, such as arcade machines, bars, countertops, armoires, and other traditional pieces of furniture. This may include using a drawer design to hide arcade style controls until desired, or a direct mounting of the arcade style controls on any surface.

These and other objects of the present invention will become apparent when considering the following detailed description and drawings of the present invention.

### BRIEF DESCRIPTION OF THE DRAWINGS

FIG. 1 is a front view of the video game and entertainment cabinet according to an embodiment of the present invention;

FIG. 1A is a front exploded view of an alternative form of the video game and entertainment cabinet according to an embodiment of the present invention.

FIG. 2 is a side view of the television tilt mechanism of the present invention with the television tilted downwardly;

FIG. 3 is a side view of the television tilt mechanism of the present invention with television in the upright and level position;

FIG. 4 is a rear view of the television tilt mechanism of the present invention with the television tilted downwardly;

FIGS. 5A-5C are side views of an alternate embodiment of the tilt mechanism;

FIG. 6 is a schematic of an example of an electrical connection between the arcade style controllers, the video game system and the television or monitor;

FIG. 7 is alternative example of an electrical connection between the arcade style controllers and the video game system;

FIG. 7A FIG. 16 is a schematic representation of a wireless control device compatible for use with multiple game systems according to the invention;

FIG. 8 is an example of the use of a CD changer in association with one or more video game systems;

FIG. 9 is an alternative example of the use of a CD changer in association with one or more video game systems;

FIG. 10 is a rear view of a CD changer for use with the arcade style video game and entertainment cabinet of the present invention;

FIG. 11 is a side view of a slide out drawer of the arcade style video game and entertainment cabinet of the present invention;

FIG. 12 is an example of the arcade style controller on a pull out drawer that is installed in a typical bar/countertop;

FIG. 13 is a schematic of how a timer device could be attached to the power of a home game system and the controls of a home game system;

FIG. 14 is an overview of a game selection switching board that allows several game systems to be connected, simultaneously, to a single control device, such as the arcade style control board, joysticks, and buttons;

FIG. 15 is a depiction of possible applications for an arcade style controller plate that is used to give arcade style control to multiple types of cabinets;

FIG. 16 is a schematic representation of a wireless control device compatible for use with multiple game systems according to the invention

### DETAILED DESCRIPTION OF THE INVENTION

Reference will now be made in detail to the present preferred embodiments of the present invention, examples of which are illustrated in the accompanying drawings. Whenever possible, the same reference numbers will be used throughout the drawings to refer to the same or like parts.

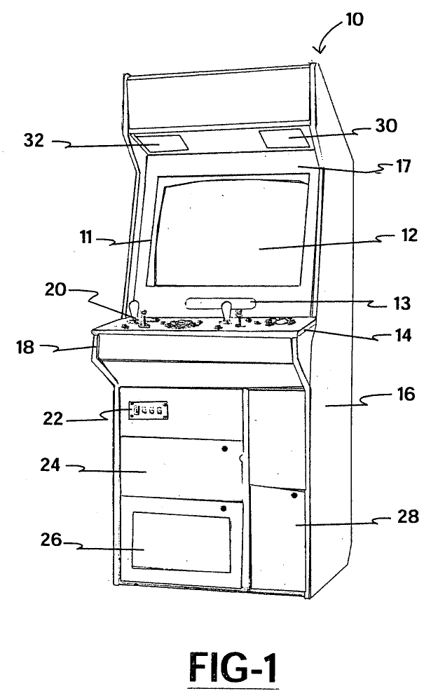

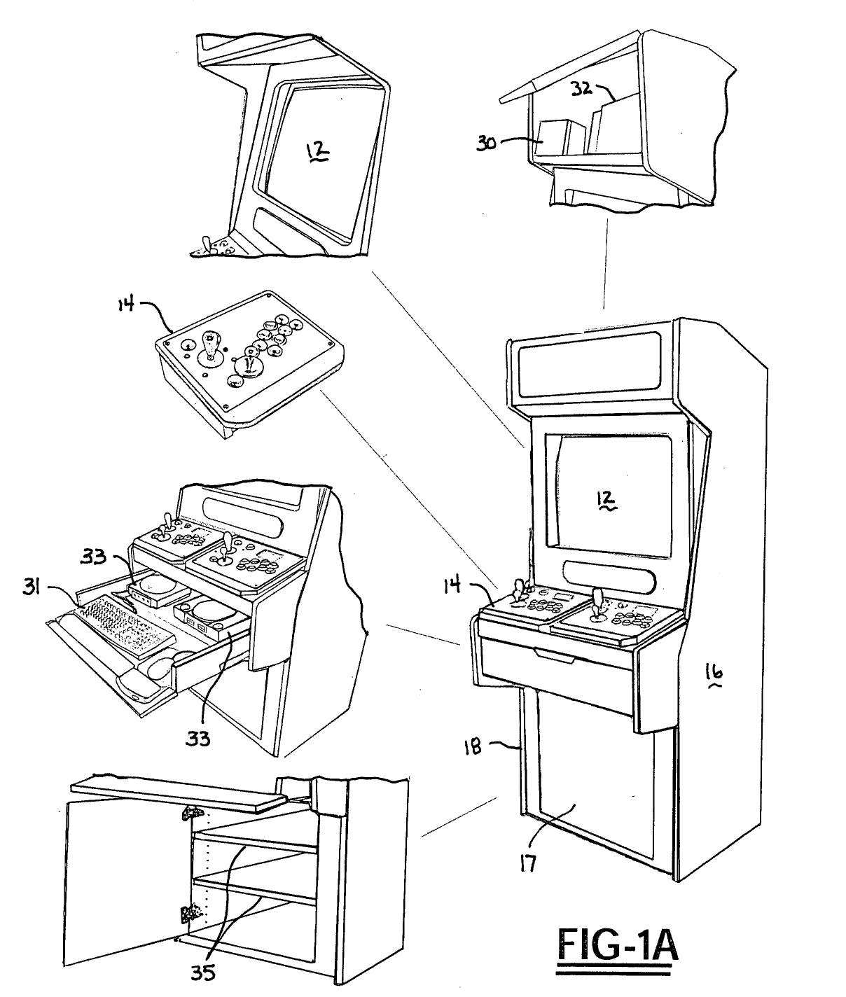

In FIG. 1, there is shown generally at 10, an embodiment of the video game adapting system and entertainment cabinet of the present invention. The system 10 may be of any suitable configuration, and is shown in this embodiment, as an arcade style video game cabinet. The cabinet includes two sides 16 and 18, a front 17 and a top and back (not shown) in a normal fashion. The front 17 of the cabinet may have an opening 11, which allows for viewing of the screen 12 of the television or monitor which is housed within the system 10. As will be described in more detail hereafter, the screen 12 may be tiltable within the cabinet to different viewing positions. Opening 13 allows access to television buttons and controls. The cabinet and other components of the system may be configured as a knock down assembly, which is assembled by the user to facilitate shipping and handling. The system 10 may be stand alone or configured to be supported on a tabletop or other surface. Cabinet front 17 may also have a control platform 14 built therein. The control platform 14 has several apertures and openings formed within it for placement of various game controls 20, described in detail below. As seen in FIG. 1A, the platform 14 may be configured to be removable from the cabinet for play at a remote location, either through a wire or wireless connection. Below platform 14 may be located drawers for placement and housing of the various video game systems and other electronic components, accessories, games and the like used with the video game and entertainment system. In the example shown in FIG. 1 there is an power control panel 22, a middle drawer 24 and a lower drawer 26 placed below control platform 14. Additionally, there is a side drawer 28 placed adjacent to the drawers 24 and 26. As seen in FIG. 1A, there may also be provided a drawer 29, which may house a keyboard 31 for a computer or game system housed in the cabinet. Game systems 33 may also be housed within this additional drawer if desired. To allow access to these systems, the drawer 29 may be slid to an outwardly extended position. As a further alternative to the drawers 24 and 26 of the FIG. 1 embodiment, shelving 35 may be provided in the cabinet as seen in FIG. 1a if desired. It is to be understood that the configuration of the drawers/shelving as shown in FIG. 1 and FIG. 1A are examples only and that various storage compartment configurations are contemplated by the present invention. Cabinet 10 is constructed from rigid materials such as, for example furniture grade wood, laminated materials, plastic, metal or any other suitable material.

As also shown in FIG. 1, the cabinet 10 may be configured to house one or more speakers 30 and 32. As seen in FIG. 1A, speakers 30 and 32 may be assembled in an upper storage compartment, which may be used for other accessories or the like. The placement of the speakers in the front 17 of cabinet 10 is for example only, as speakers 30 and 32 could be placed at different locations in cabinet 10 to achieve the best sound. Furthermore, additional speakers, either housed within cabinet 10 or satellite speakers, could be used in association with the video game and entertainment cabinet 10 of the present invention. For example, an integrated or external seat could be provided for use with the system 10, being connected to the system for interactive game playing, similar to some arcade style games. A vibration or movement system, and speakers could be provided with the seat in such an example.

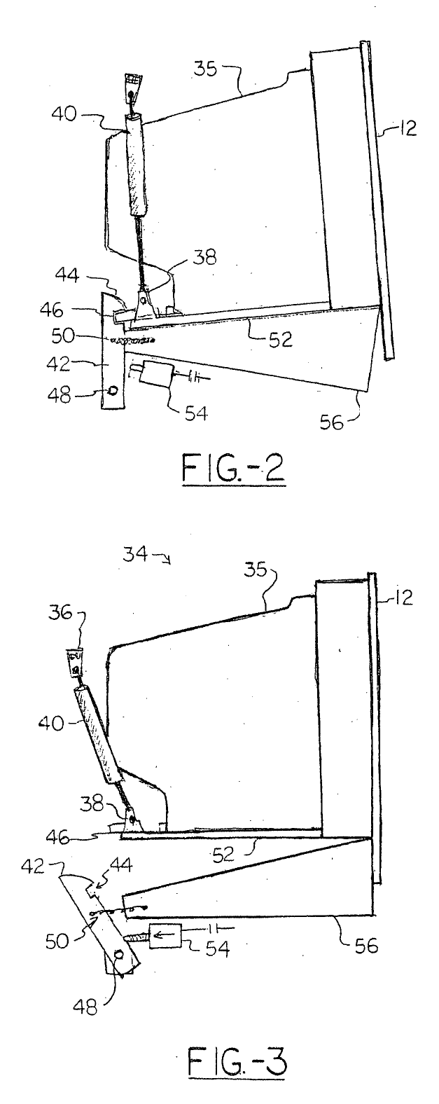

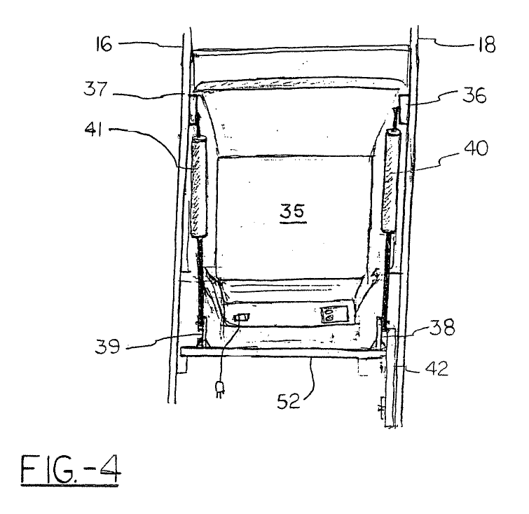

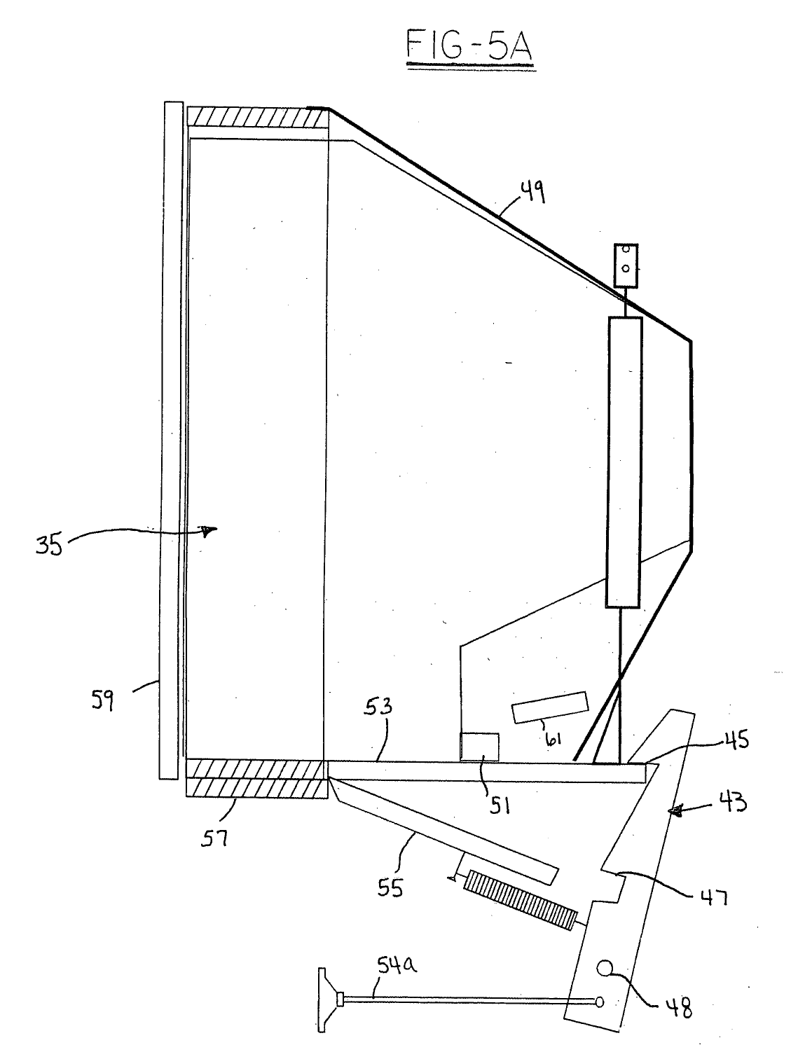

Within cabinet 10 is provided a television/monitor support system 34, which allows for positioning and support of a television/monitor of a predetermined size. In the example shown, a cabinet of this type may house a standard size TV, such as a 25″ screen or any other suitable size. The support system 34 also provides selective angular movement or tilting of the television/monitor 35 to allow for optimal viewing of the television or monitor 35 in alternative uses. When playing video games, the user may be positioned to use the controls on control platform 14. In this position, the support system 34 enables the TV/monitor 35 to be tilted backward to an optimized position for playing. While watching television or other video formats, the support system 34 enables the TV/monitor 35 to be tilted forwardly from a horizontal position to facilitate viewing of the TV/monitor depending upon where the user is positioned. As will be described in more detail hereafter, the present invention also provides for wireless controllers which may be used from a position remote from cabinet 10, for which the alternative positioning of TV/monitor 35 will facilitate proper viewing. Turning to FIGS. 2-5, the support system 34 is shown in more detail. The television/monitor support system 34 provides support for television/monitor 35 via a platform 52. Platform 52 is selectively pivotable to allow television/monitor 35 to be variably positioned.

To facilitate use of the TV/monitor support system, the TV/monitor 35 may be selectively positioned within an independent housing or box-like structure, which can be easily slid into proper position with respect to platform 52 of the support system 34. Alternatively, the TV/monitor 35 may be positioned directly upon platform 52. In either case, it is desirable to secure the TV/monitor 35 thereto to prevent movement of the TV 35 during repositioning of the support system 34.

The front of platform 52 is pivotally attached to the base 56 of the television/monitor support system 34. At the back of platform 52 is a peg 46 which is engaged by a notch 44 formed in the support bracket 42 to lock platform 52 in the downwardly tilting position. Support bracket 42 is pivotally attached to the cabinet 10 by a pivot bolt 48 located at the lower end of support bracket 42.

The television support system also includes cylinders 40 and 41 which raise and lower platform 52 when desired. Cylinders 40 and 41 are attached at their upper ends to brackets 36 and 37, which are attached to the sidewalls 16 and 18 of cabinet 10. Cylinders 40, 41 are attached to brackets 38, 39 secured to the lateral edges of platform 52. Cylinders 40, 41 may be either hydraulic or pneumatic as necessary to raise and lower platform 52 and television 35.

In operation, when it is desired to view television 35 in the upright position, the operator causes support bracket 42 to be forced toward the back of cabinet 10, in order to remove peg 46 from notch 44. This can be done, for example, by a solenoid affixed adjacent to support bracket 42. After peg 46 is no longer within notch 46, cylinders 40, 41 operate to raise platform 52 and television 35.

After platform 52 and television 35 have been raised to the horizontal position, spring 50 pulls support bracket 42 back into its normal position. When it is desired to utilize television 35 in the downwardly tilting position, cylinders 40, 41 are extended. As platform 52 and television 35 are lowered, peg 46 comes into contact with the curved upper portion of support bracket 42, which forces support bracket 42 rearwardly. As platform 52 and television 35 come to rest on base 56, peg 46 is locked into place in notch 44.

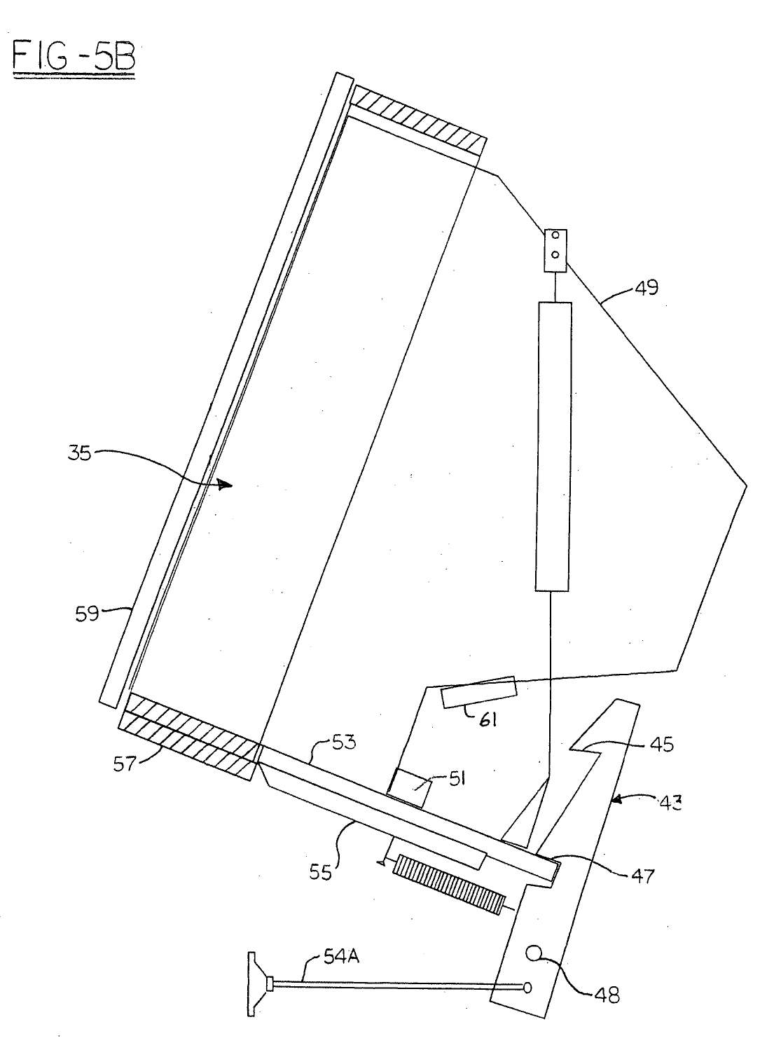

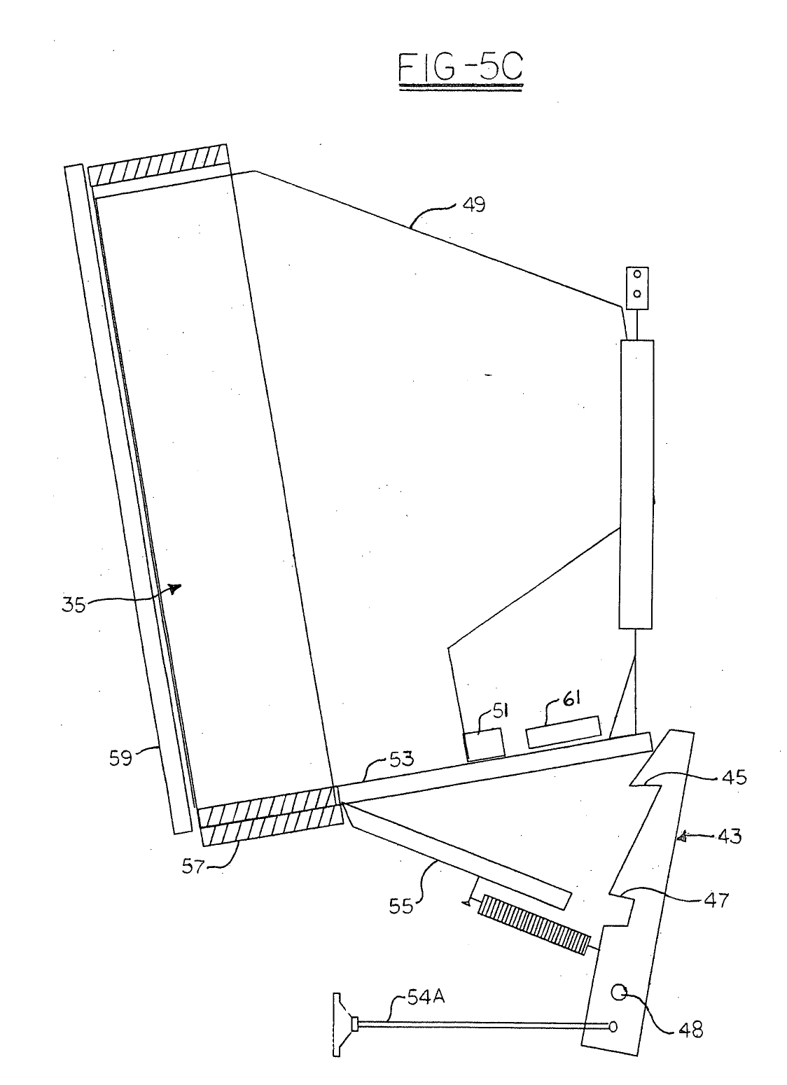

In FIGS. 5A, 5B and 5C, an alternative embodiment of the tilt mechanism is shown for variably positioning the TV/monitor 35. In FIG. 5A, the TV/monitor 35 is positioned horizontally on platform 53. The platform 53 extends into engagement with a latch mechanism 43 having a plurality of stops 45 and 47 for engaging platform 53. As seen in FIG. 5A, platform 53 engages stop 45 when positioned in the horizontal viewing position. The platform 53 in turn is supported on a pivotable shelf 55 including a front pivoting section 57. There may also be provided an adjustable front panel 59, which may be secured in position around the front face of the TV/monitor opening to effectively conceal portions of the TV/monitor 35 except for the viewing screen. The front panel 59 may be secured in position by means of hook and loop fasteners or other appropriate fastening system as desired. To prevent movement of the TV/monitor 35 during repositioning, an adjustable strap 49 may be used for securing TV 35 in position. There may also be provided an adjustable brace 51, which is selectively secured in position relative to a back surface of the TV/monitor 35. As seen in FIGS. 5B and 5C, the entire support system is then pivotable between a back tilt position as shown in FIG. 5B and a front tilt view as shown in FIG. 5C. As in the previous embodiment, a suitable actuating mechanism such as a knob 54A to selectively reposition to latch 43. Movement of knob 54A causes pivoting of latch 43 about pivot point 48 to selectively release platform 53 from engagement therewith. The platform 53 is then reengaged in association with stop 47 in the back tilt view position as shown in FIG. 5B, or is not engaged by the latch 43 in the front tilt view as shown in FIG. 5C. In the front tilt view, a stop bracket 61 secured in association with cabinet 10 will engage platform 53 as shown in FIG. 5C. The angled faces above each of the stops 45 and 47 of latch 43 thereafter facilitating repositioning of the platform 53 in association with one of the stops as the platform 53 is moved from the front tilt view from the horizontal or back tilt views.

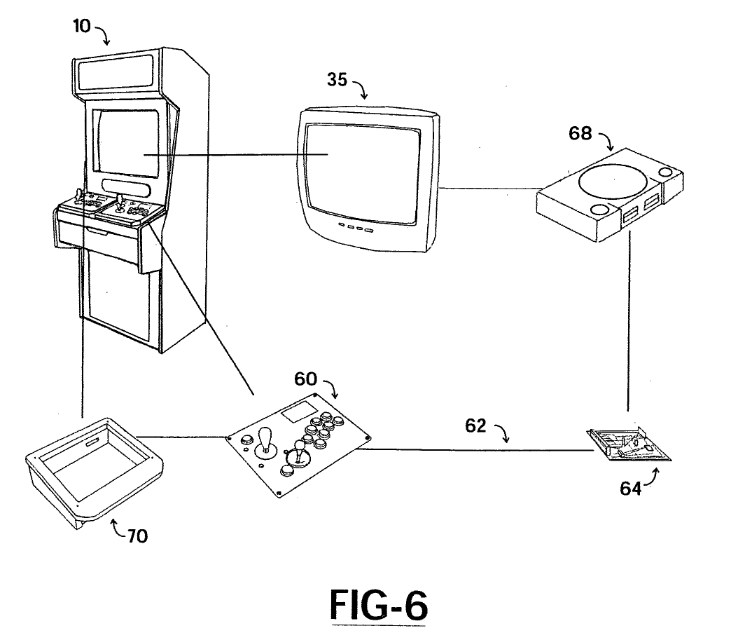

In FIG. 6 there is shown one manner in which the arcade style controls may be electrically connected with the home video game system. The control panel 60, which includes authentic arcade controls is connected to a circuit board 64 by a 25-pin wire harness 62. Circuit board 64 is electrically connected to the home video game system 68 by a wiring harness that fits a game controller port standard with the game system 68. The game system 68 is then electrically connected with the television or monitor 35, housed within system 10, likewise by the wiring harness, which is provided by the game system manufacturer. Control panel 60 is permanently mounted to the cabinet of system 10 in a cutout formed in platform 14, or is mounted in controller box 70 which is easily removable from platform 14 (shown in FIG. 1) of system 10, as an example. The circuit board 64 is configured to connect the controllers on control panel 60, to the game system 68, to replace the hand-held controllers of the home game system and use the arcade style controllers. The user can also switch back to use of the hand-held controllers when desired, which is achieved by a switchbox or by changing controllers.

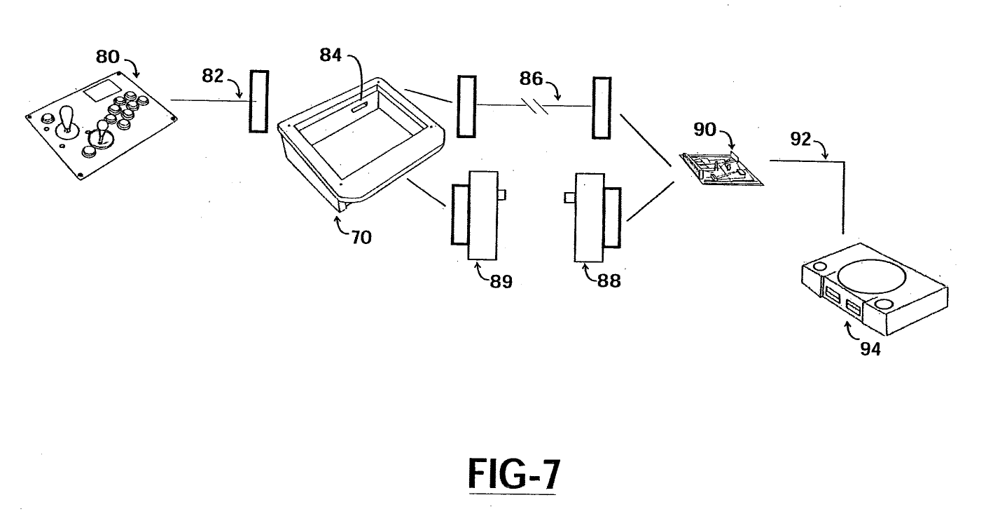

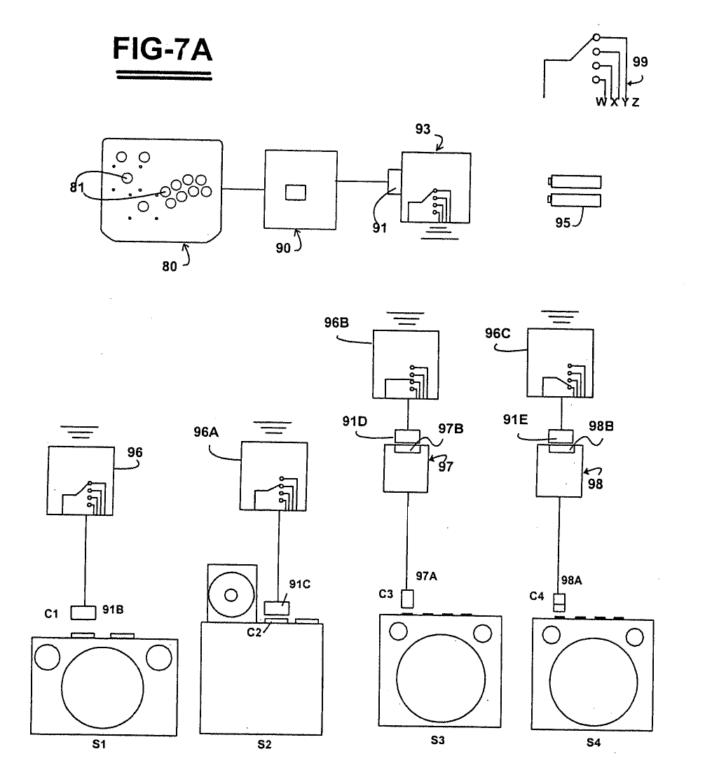

FIG. 7 illustrates an alternative embodiment for electrically connecting the arcade style video game controls to the home video game system and television. Control panel 80 is connected to a mounting plate 84 located on the rear side of the controller box. At the mounting plate 84 may be attached a 25 pin extension wiring harness 86 that allows the controller box to be removed and extended from the platform 14 of system 10. A 25 pin extension wiring harness 86 is connected to a printed circuit board 90 which has the controller codes programmed therein. The printed circuit board 90 is connected to the game system 94 by a cable similar to those provided with the home video game system 94. These modular controllers may then be moved away from system 10, to allow play similar to the use of the hand-held controllers, but using the arcade style controls. Circuit board 90 can be easily replaced with an alternative circuit board that contains controller codes for game systems introduced in the future.

Alternatively, a wireless controller module may be provided. As seen in FIG. 7A, a wireless system according to an embodiment of the invention provides a combination of devices which function together to make a video game controller both wireless and compatible with multiple video game systems. The controller module 80, providing a set of buttons and joysticks generally designated 81, which are electrically connected to a printed circuit board 90. The printed circuit board 90 is in turn connected to a cable and plug 91, which is designed to connect to a first game system S1 through a port C1 on the game system S1. Instead of this normal connection, the video game controller 80 becomes wireless by adding RF transmitting capabilities. The connection 91 is instead made to a RF transmitter 93 containing an integrated circuit with firmware, and RF hardware for transmitting an RF signal dependent upon use of the control systems 81. A battery power supply 95 may be used to power the RF transmitter or other suitable source. Associated with the game system S1, a RF receiver 96, capable of communicating with the transmitter 93 through RF hardware and firmware, is connected to the game system S1 through a plug 91B. The receiver 96 and transmitter 93 communicate via RF signals, and the video game controller 80 operates as it would with a hardwired connection yet allowing the controller 80 to be freely moved within the general vicinity of the game system S1.

The controller 80 is also usable to control operation of a second game system S2, having a port C2 identical to the port C1 on game system S1. Such an additional game system may be connected to the controller 80 by adding an additional receiver 96A. The second receiver 96A receives the signals from the transmitter 93, and game system S2 is operated thereby. Two or more game systems having identical plugs C1 and C2 can therefore be operated by adding a receiver 96 or 96A using video controller 80, without having to unplug one system and plug in the other.

As a further feature of the video game controller system 80, any other alternative game system may be adapted to work therewith. As shown in FIG. 7A, a further game system S3 may be adapted to use with the controller 80 by means of a converter or adapter 97 having a plug 97A configured to match output port C3 associated with game system S3. The adapter 97 further includes an output port 97B to match plug 91D associated with the receiver 96B. Similarly, for a game system S4, an adapter 98 may connect the input port C4 to the receiver 96C for control of game system S4.

Thus, connecting multiple game platforms (S1, S2, S3, S4) simultaneously, without having to physically switch any wires, or electrical connections, allow the user to simply change the system which the controller operates. A receiver is added to the individual game systems for use with the single video game controller 80. If the signals from the transmitter 93 associated with controller 80 require conversion for operation of an alternative game system, an adapter is provided for coupling therewith. If two or more game systems were to be operating at the same time, which may be possible using multiple monitors within the cabinet 10, it may be possible that interference between RF signals from the transmitter 93 and the respective receivers of the multiple game systems S1-S4 could cause problems. The transmitter 93 and receiver 96 may therefore be configured to communicate on independent frequencies to separate control signals for each game system and avoid such interference. A switch 99 may be used to select transmitter options on transmitter 93, to which the independent receivers 96, 96A, 96B, and 96C are selectively matched via a switch positioned thereon.

With respect to the above controller system, it should be recognized that the forms of connection as described are only one possible form, and other hardwired or suitable connections are contemplated. It should also be recognized that for game systems supporting multiple players, a plurality of video game controllers would be connected to the game system similarly. Also, if the controller systems 80 are adapted to proved interactive features, both transmitter 93 and receiver 96 may be configured as transceivers to both send and receive RF signals between these components.

As an alternative example of wireless control, FIG. 7 shows another form of wireless communication and connection method as an example, relating to an infrared wireless link. In this case, as shown in FIG. 7, an infrared adapter 89 is connected to the mounting plate 84 and a second infrared adapter 88 is attached to the printed circuit board 90. Through the infrared light waves generated by adapter 89 the movements selected by the operator at the controls are received by adapter 88 and communicated to circuit board 90.

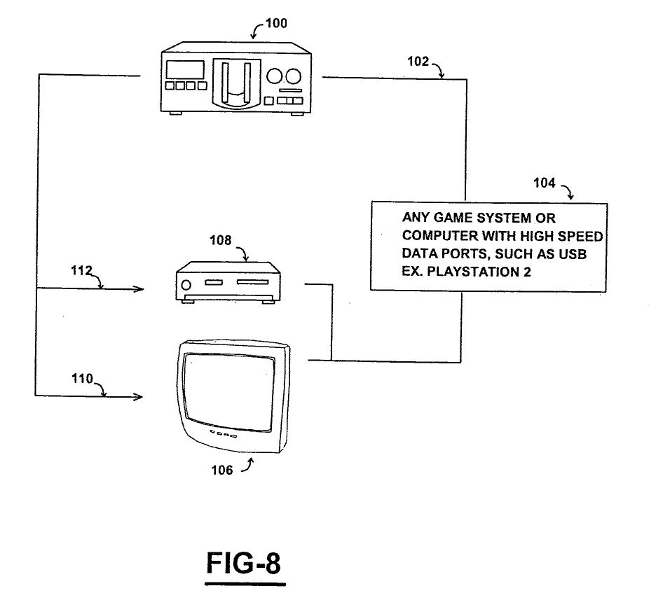

Now referring to FIG. 8 there is shown the optional CD changer feature used in conjunction with the arcade style video game and entertainment cabinet of the present invention. A CD or DVD changer 100 equipped with a Universal Serial Bus or other high-speed data port, such as a firewire port, is housed within cabinet 10. CD changer 100 is connected via a high speed data cable to one of many home video game systems or home computers, such as for example, MICROSOFT XBOX, SONY PLAYSTATION 2, MACINTOSH/APPLE computers, IBM PC and compatible computer systems, or any other system equipped with high speed data transfer support. The video game system 104 is connected to a television 106 and a stereo receiver 108 housed within cabinet 10 (not shown). Optionally, television 106 and receiver 108 are connected to CD changer 100 directly via AV cables 110 and 112, respectively. Cable 110 and cable 112 are necessary if game system 104 is not present and the CD changer 100 is to function without high-speed data transfer. Optionally, CD changer 100 may be connected to an extra controller, a keyboard or a mouse to allow the operator to select and/or control the CD and the associated video game encoded on the CD. CD changer 100 may also be controlled through controllers connected to game system 104. Furthermore, a remote control may be utilized for selection of a CD from CD changer 100.

The multidisc changer can hold compact discs, DVD's and/or other discs encoded with digital audio, video, video game and movie data. The disc changers have fast load times which enhances video game systems. The disc changer operates on its own without game support, however licensed technology for onboard game support is optional. The disc changer also prevents the discs from becoming damaged, decreases game change time, and may act as a central hub for use by all game, video and audio components.

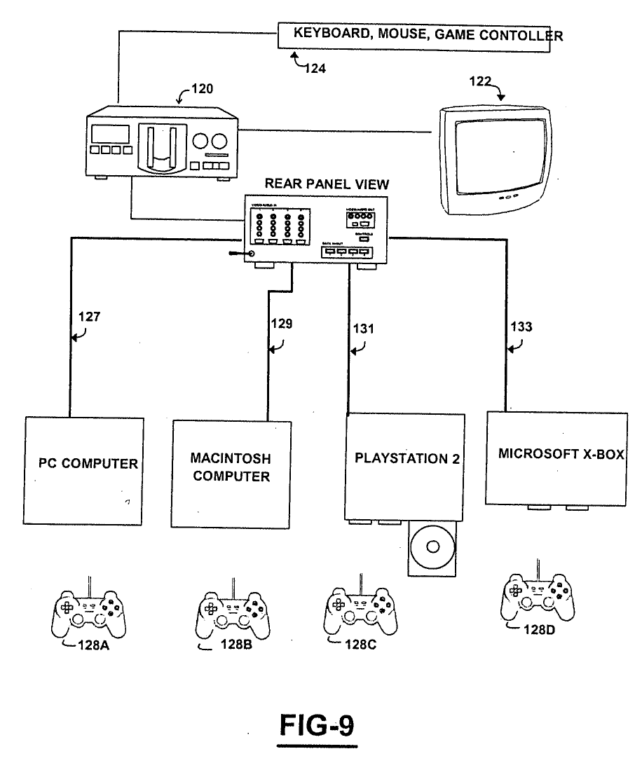

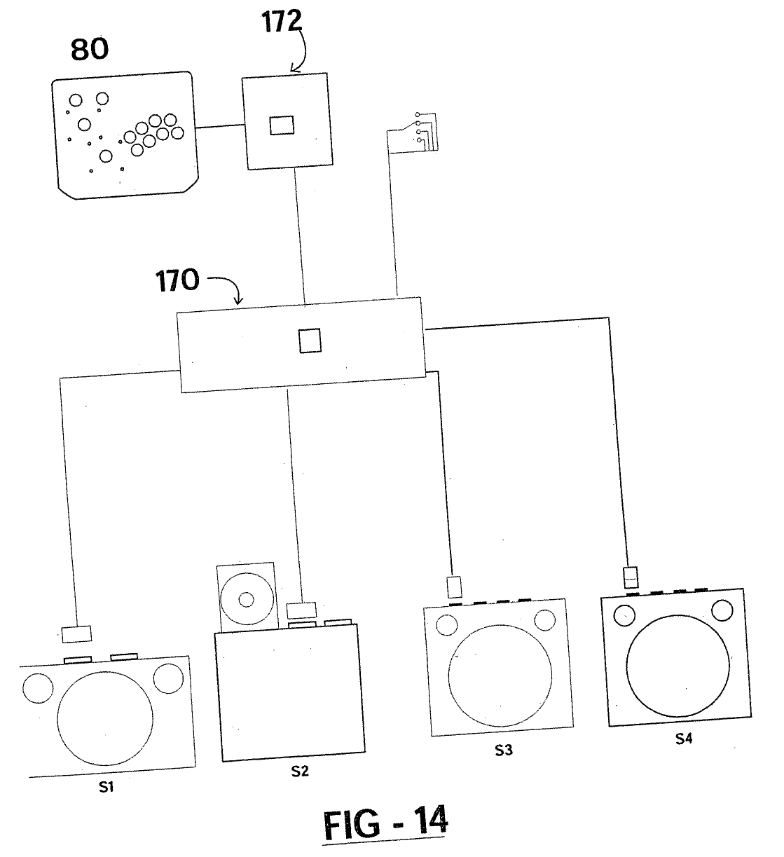

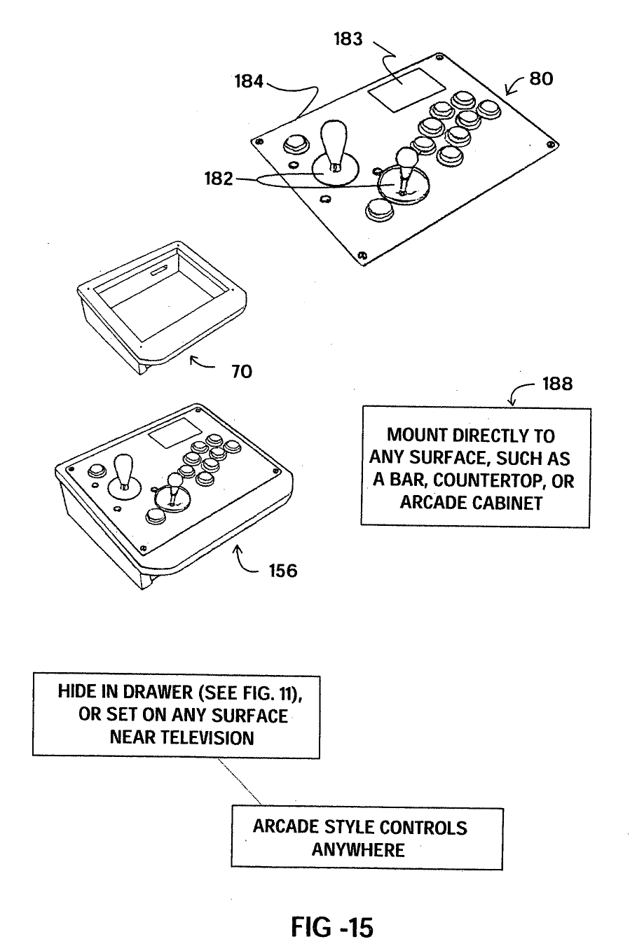

Referring now to FIG. 9, there is shown another optional arrangement of a multidisc CD changer. In this arrangement, a CD changer 120 is connected to the controls 124, such as a keyboard, mouse or arcade style game controllers, and a television or monitor 122, just as the previously described arrangements. The CD changer 120 acts as a data hub, which allows for connection to multiple game systems 128, 130, 132, 134 via high-speed data and AV cables 127, 129, 131 and 133. These game systems may be, for example, a MICROSOFT XBOX, a PC based computer system, a MACINTOSH computer system and a SONY PLAYSTATION 2 video game system. CD changer 120 holds all formats of compact discs and digital video discs for each of the selected game systems. CD changer 120 selects the game system to be utilized by knowing the disc format and matching the disc with the correct game system. CD titles are displayed on television 122 and are selected using controls 124 or game system controllers 128A-D. CD changer 120 may also contain switching technology, such as that illustrated in FIG. 14, which allows a single controller to operate all game systems and CD changer 120, thereby using separate controllers 128A-D becomes unnecessary. CD changer 120 may also have audio and video inputs for each of the video game systems, which enables the overall system to control audio and video selection by disc format.

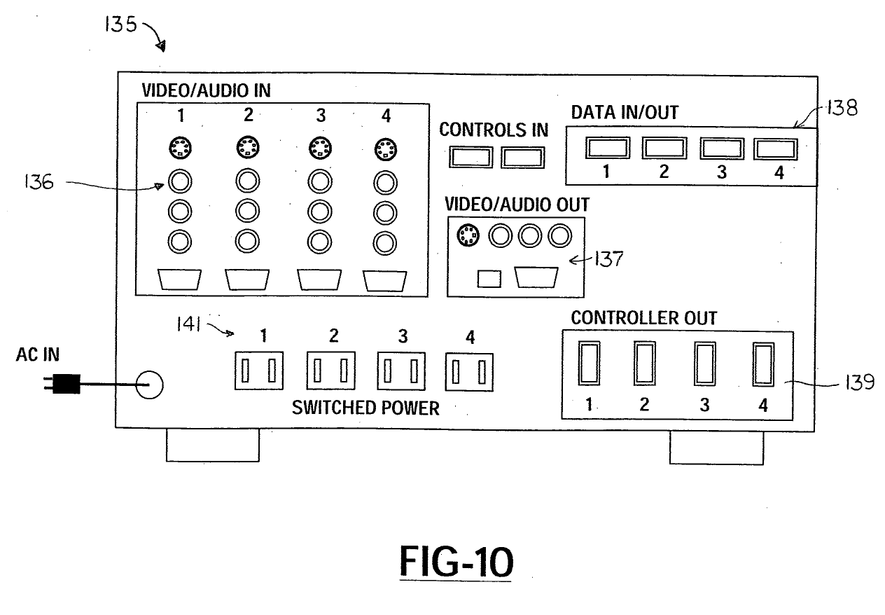

As shown in FIG. 10 there is shown a possible arrangement of the back panel of a CD changer 135 used in association with the arcade style video game and entertainment cabinet of the present invention. The back panel is provided with a number of ports 136 for data, audio, and video input and output. Standard ports for input could include composite audio and video ports, S-Video ports, SVGA ports, RGB ports, and other such ports for obtaining audio and video data from game systems. The audio and video of the desired input is then outputted through similar ports 137, which are connected to a television or monitor. A high-speed data hub may also exist on the rear panel. This data hub 138 functions to send and receive data to and from the selected game system via high-speed data cables. In the case where the data port does not send or receive game control data, separate controller ports may exist on the rear panel to connect to the controller ports 139 of these game systems. In this manner, a single controller connected to CD changer 135 could control any game system in which it is connected. As mentioned previously, CD changer 135 may function as a central hub to organize various data discs and to expedite game swapping. CD changer 135 may also control the power to the game systems or other components via switched AC plugs 141.

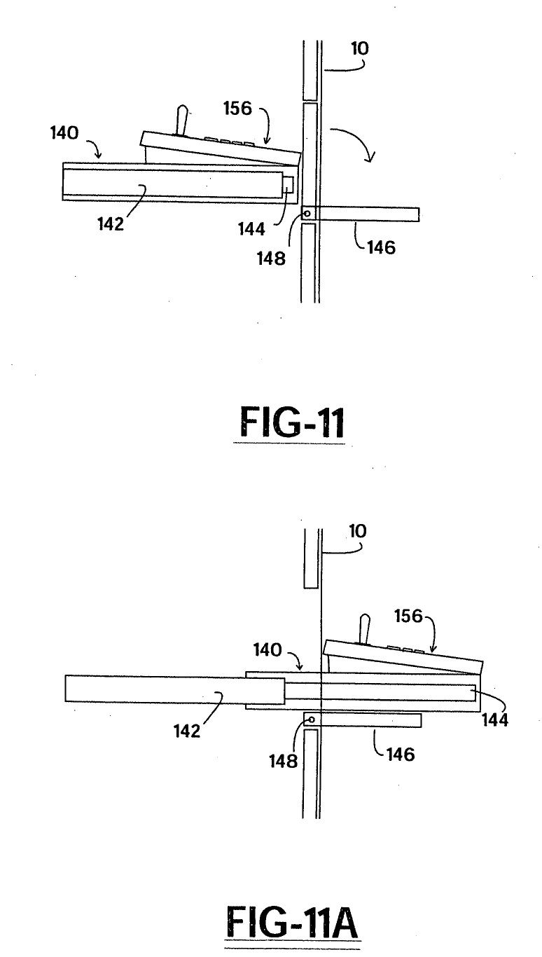

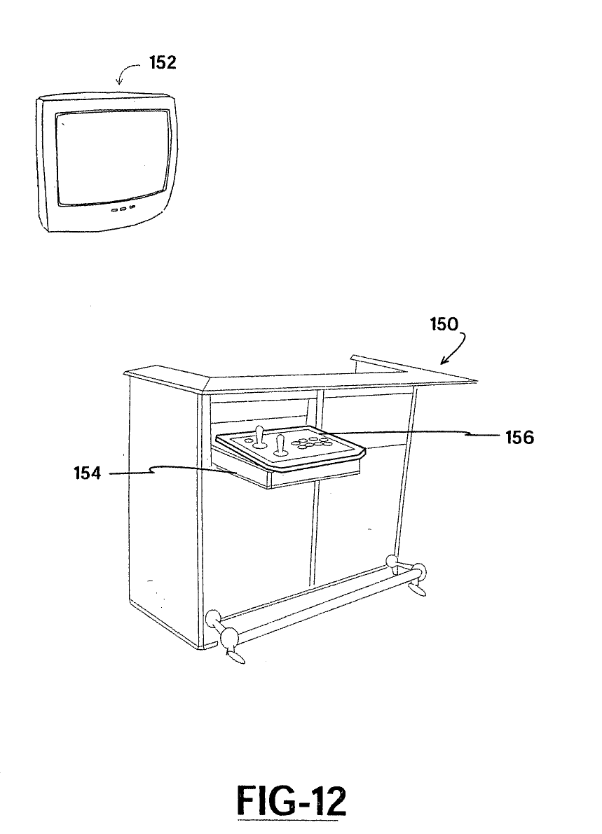

In FIG. 11, there is shown an optional feature of a drawer 140 placed within cabinet 10 of the present invention. Drawer 140 is provided with a male runner 144 on each side of drawer 140, which fits within a female runner 142 affixed to the sides 16, 18 of cabinet 10. Drawer 140 has a face 146 which pivots about hinge 148 to rest underneath the bottom of drawer 140. Hiding the arcade style controllers in cabinet 10 makes the cabinet an entertainment center that turns into an arcade machine. This drawer could also be installed, for example, in a bar under the countertop connected to a television/monitor on or behind the bar as shown in FIG. 12. This further increases the versatility of the cabinet 10 of the present invention, as this allows operators to utilize their home video game systems as originally designed, in addition to being able to control the game system through of the arcade style game controllers.

Turning to FIG. 12, as previously mentioned, the system according to the invention may be configured in a different housing or cabinet construction as desired. In FIG. 12, such an alternative arrangement is shown to include a bar type of structure 150 which is situated at a remote position with respect to a television/monitor 152. A drawer 154 may house a plurality of controllers 156 for operation of game systems coupled to TV/monitor 152. The controller 156 may again provide arcade style controls and game play in an environment in which such systems are not normally used. As an alternative, the TV/monitor 152 could be built into the bar assembly 150 and/or the game systems may be housed therein.

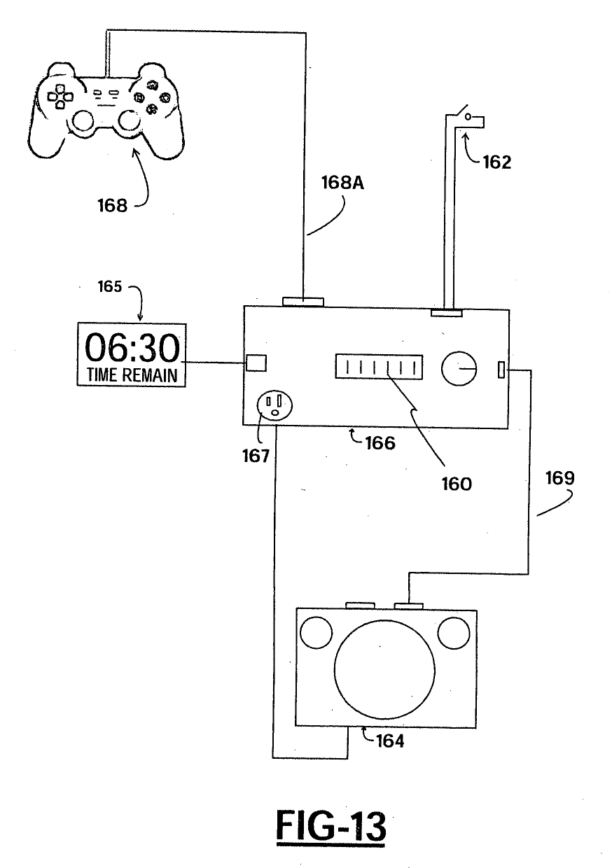

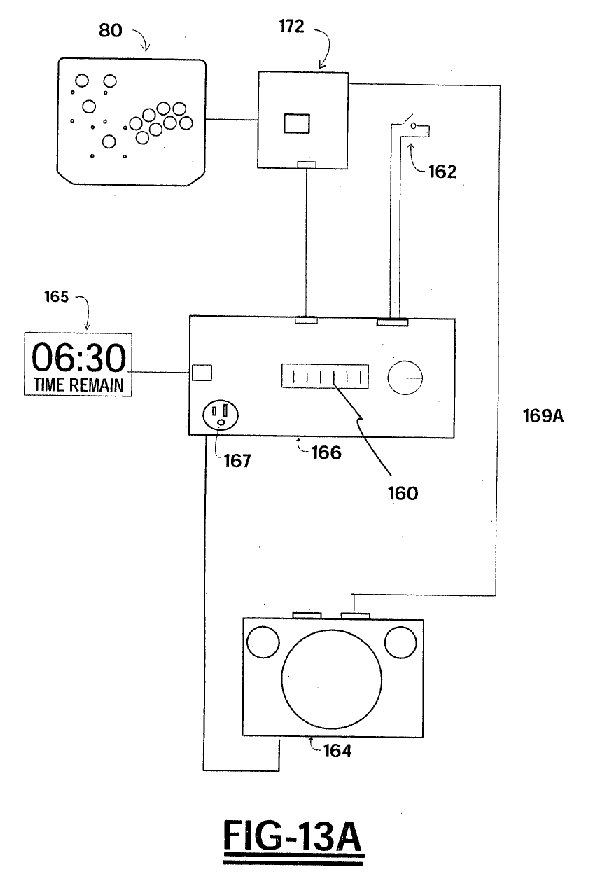

In FIG. 13, a control system for controlling operation of the game systems according to the invention is shown. The control system allows the user to enable play of a game system in a selective or controlled manner. In this way, a parent can control usage by their children, or a commercial enterprise could control usage by patrons or the like. A switch 162 is coupled to a timer module 166. The timer module 166 in turn is connected to a hand held controller 168 which contains a circuit board for coding operation of the joysticks and buttons on the controller 168. Timer module 166 is connected to game system 164 via harness 169, which has a connector identical to cable 168A compatible with game system 164. The user may then select a time for switch activation on timer module 166 using dipswitches and controls 160, triggered by switch 162 such that when such time has elapsed, as indicated by numerical indicator 165, the controller 168 will be disabled, thereby rendering the game system inoperative. The timer module 166 could optionally trigger the power to the game system to momentarily turn off, thereby resetting the home game system, as shown in AC power control 167. In this way, a parent could limit the time which children spend playing the game systems or a system for charging for game play could be established based upon the control of the timer module and ultimately of the game systems based upon the usage time. If desired, the control over operation of the game system could be integrated with a coin or token activator, requiring deposit of a coin or token to allow play. Alternative mechanisms for controlling operation of the game systems to selectively permit operation thereof are contemplated, and could be triggered to the occurrence of certain events within a game scenario, such as with arcade games, or could be controlled in some other manner as desired. FIG. 13A depicts the timer module 166 connected to control panel 80 and circuit board 172. In this alternative configuration, the timer module 166 does not need to connect directly to the game system 164 as it disables circuit board 172 directly, which is connect to game system 164 via harness 169A.

As previously mentioned with respect to a wireless controller, the present invention provides for coupling and operation of multiple game systems without reconfirming wiring or hookups. As seen in FIG. 14, game systems 1, 2, 3 . . . are coupled to a switching board 170 which the user may set to select a particular game system. The switching board 170 is in turn coupled to a game system board 172, which would contain all controller conversion data for each of the game systems to which it is connected. The game system board 172 is therefore desirably made expandable to allow other game systems to be attached thereto while providing proper controller conversion data to the joysticks and buttons associated with the controller attached thereto. This switching assembly demonstrates a basic nonwireless solution that simply switches all necessary contacts to the desired game system. The switching board 170 requires the necessary firmware for each game system for proper operation.

In FIG. 15, the arcade style control module generally indicated at 180 may comprise suitable controls 182 mounted on a mounting plate 184 and an interchangeable graphic legend 183. The mounting plate 184 may in turn be selectively mounted to a controller box 70 or other housing by a suitable attachment system, such as screws, bolts, hook and loop fasteners or the like, for a combined result similar to controller 156. Alternatively, the mounting plate 184 could be mounted directly to an arcade cabinet 10 as described in earlier embodiments, such as directly to platform 14 or to another surface as generally indicated at 188. Attachments to the cabinet or other surface at 188 may also be accomplished by suitable fastening mechanisms. In this manner, the arcade style control panel may be easily moved and reconfigured for alternative uses, providing flexibility to the use of the controllers.

Although the principles, preferred embodiments and preferred operation of the present invention have been described in detail herein, this is not to be construed as being limited to the particular illustrative forms disclosed. It will thus become apparent to those skilled in the art that various modifications of the preferred embodiments herein can be made without departing from the spirit or scope of the invention.

What is claimed is:

1. A video game conversion system comprising,
a housing,
a video game adapter system for coupling at least one video game system having at least a first hand-held controller associated therewith, the adapter system coupling an input port of the at least one video game system to at least one second controller, wherein the at least one second controller has at least one arcade control system associated therewith.

2. The system according to claim 1, wherein the housing supports a TV/monitor therein.

3. The system according to claim 2, wherein the position of the TV/monitor is variable with respect to the housing.

4. The system according to claim 1, wherein the housing includes a shelf on which a TV/monitor is positioned and secured.

5. The system according to claim 4, wherein the shelf is selectively pivotable to vary the position of a TV/monitor supported thereon with respect to the housing.

6. The system according to claim 5, wherein the shelf is pivotable between a tilted forward orientation, a horizontal orientation and a tilted backward orientation.

7. The system according to claim 1, wherein the arcade control system is a digital or analog joystick and multiple buttons.

8. The system according to claim 1, wherein the arcade control system comprises a digital and analog joy stick.

9. The system according to claim 1, wherein a plurality of game systems are provided, and the video game adapter system comprises a switching system to allow the user to select which game system is operated by the at least one second controller.

10. The system according to claim 1, wherein the at least one second controller comprises a wireless transmitter to send data regarding the at least one arcade control system to a wireless receiver associated with the video game adapter system.

11. The system according to claim 1, wherein the adapter system further comprises a control system to selectively disable operation of the at least one video game by means of the at least one second controller.

12. The system according to claim 11, wherein the control system comprises a timer module which terminates power to the adapter system after a predetermined elapsed time.

13. The system according to claim 11, wherein the control system comprises a timer module which disables operation of the controller and terminates power to a video game system after a predetermined elapsed time.

14. The system according to claim 1, further comprising a multi disc changer coupled to the at least one video game system for selection of different games stored on discs therein.

15. A video game cabinet, comprising, a housing having a support for a TV/monitor therein, the support being selectively positionable to vary the orientation of the TV/monitor with respect to the housing.

16. The cabinet according to claim 15, wherein the support is selectively positionable between tilted forward and tilted backward orientations with respect to a horizontal position in the housing.

17. The cabinet according to claim 15, wherein the support is selectively pivotable within the cabinet by a user.

18. A universal video game controller comprising,
at least one control system for generating information for controlling a video game,
a transmitter coupled to the at least one control system for converting information into a form for wireless transmission,
at least two video game systems, having an input port for coupling information generated by at least one control system, and each having a receiver coupled to the input port for converting wireless transmission from the transmitter for signals for controlling a respective video game.

19. The controller according to claim 18, wherein the wireless transmission is accomplished by a system selected from the group consisting of RF transmitter/.receiver, IR transmifter/receiver.

20. The controller according to claim 18, wherein an adapter is provided in association with the input port to convert signals from the transmitter to a proper configuration for operation of a particular video game.

21. The controller according to claim 18 further comprising a switch device to selectively switch between different video game systems, wherein wireless transmission associated with each prospective game system will not interfere with transmission of other game systems.

22. A video game control system comprising,
a video game having at least one controller, and being coupled to a source of AC power,
a control device interconnected to the video game, by which operation of the video game may be controlled to play selectively of the video game.
